(19) United States
(12) Patent Application Publication
(10) Pub. No.: US 2005/0049731 A1
(43) Pub. Date: Mar. 3, 2005

(54) Interactive wagering contest method and system

(76) Inventor: Terry Dell, Charlotte, NC (US)

Correspondence Address: WOMBLE CARLYLE SANDRIDGE & RICE, PLLC, P.O. BOX 7037, ATLANTA, GA, 30357-0037, US

(21) Appl. No.: 10/903,540

(22) Filed: Jul. 30, 2004

(51) Int. Cl. G06F 155/00

(52) U.S. Cl. 700/91

(57) ABSTRACT

An interactive wagering game is disclosed. In the game, a plurality of participants receive an initial number of credits in respective participant accounts for use in selectively wagering credits on a finite number of competitions in a series of scheduled competitions. Participants selectively wager on the outcome of one or more competitions in the series of competitions prior to each competition. The results of each participant wager are determined based on the outcomes of each completed competition in the series of scheduled competitions, and each participant's account is credited or debited commensurate with the outcomes of each participant's respective wagers. Participants whose accounts reach zero credits are eliminated from wagering on future scheduled competitions. One or more winning participants are determined based on the highest participant account balance or balances after completion of the final competition in the series of competitions.

### FIELD OF THE INVENTION

The invention relates to interactive online computer games or contests and systems, and more specifically relates to an interactive method and system whereby contestants can compete against one another via a series of simulated wagers placed on a series of scheduled actual competitions, such as a series of scheduled sporting events or the like.

### BACKGROUND

Online interactive gaming has become increasingly popular among sports and game enthusiasts. For example, current estimates indicate that more than seven million Americans participate in so-called “fantasy sports” leagues. Fantasy sports leagues permit contestants to assemble and manage virtual sports teams in a series of games against other virtual teams assembled by other contestants. Team “owners” or “general managers” assemble these virtual sports teams from lists of actual players who are virtually “drafted” and “traded” on an interactive, Internet-based game platform. The performance of a particular virtual sports team is determined, at least in part, based upon the actual periodic performances of a team's constituent players in real-life competitions.

Some commercially sponsored websites may host free fantasy sports leagues to attract visitors to their sites. Alternatively, entry into a fantasy sports league may require payment of an entrance fee to cover the costs associated with operating and managing the computer system that hosts the league. Online fantasy sports leagues permit remotely located participants to compete against one another in spirited competition. Friends or acquaintances may group together to form their own fantasy sports “league”, or participants may participate against strangers in an established “open” league. These fantasy sports leagues permit participants to enjoy and suffer at least some of the joys and tribulations associated with operating an actual sports team—an experience that only few people have the opportunity to actually experience.

Some jurisdictions permit legal wagering on real-life competitions such as professional or college sporting events, horse racing, or the like. In such locations, persons may place wagers with a bookmaker or “bookie”. Bookmakers determine odds, and receive and pay off bets. With the advent of the Internet, online bookmaking has become common. A person can access a bookmaking website, determine the current odds on specific sporting event or the like, and selectively place a bet with a bookmaker on such an event from a remote computer. Such gambling activity is illegal in many locations, however, and many persons who might otherwise enjoy the thrill of wagering activities are precluded or dissuaded from participating in such activities. For example, some persons may be hesitant to accept the financial or legal risks associated with actual betting.

Accordingly, there is a need for an online interactive wagering game or contest whereby, similar to fantasy sports leagues, persons can vicariously enjoy the thrill of an activity in which they are unable or reluctant to actually participate. More specifically, there is a need for an online interactive wagering game or contest method and system whereby groups of persons can pit their wagering skills against one another in a safe and legal format without many of the risks associated with actual legal or illegal gambling.

### SUMMARY

The invention includes an interactive electronic gaming method. The method first includes electronically registering a plurality of game participants or players. An electronic game account is established for each registered game participant. Each game account includes an identical number of initial account credits as an initial account balance. One or more electronic credit wagers are accepted from each registered participant on one or more scheduled competitions in a series of scheduled competitions before the actual competitions. The outcome of each scheduled competition is determined. The number of account credits in each game participant's account balance is electronically adjusted commensurate with the outcome each game participant's wager or wagers on each completed competition or competitions in the series. Game participants having a current net account balance of zero credits are eliminated from further electronic wagering on any future scheduled competition or competitions in the series. A final account balance is determined for each participant after completion of a final competition in the series of competitions.

The invention also includes a system for electronic gaming. The system includes at least one host computer. The host computer is configured and programmed to: 1) register a plurality of remote game participants to compete against one another; 2) establish and maintain a unique credit account for each registered game participant; 3) accept one or more wagers from registered participants prior to each competition in a series of scheduled competitions; 4) credit and debit each unique credit account commensurate with the results of each game participant's wager or wagers subsequent to completion of each associated competition in the series of scheduled competitions; 5) eliminate a participant whose account balance is zero from further wagering on future scheduled competitions; and 6) rank the game participants based upon the participants' account balances after completion of a final competition in the series of competitions. The system further includes a plurality of remote processors in communication with the host computer. The game participants can utilize the remote processors to interactively register to participate, selectively initiate wagers on scheduled competitions, and selectively view one or more credit account balances on the host computer.

The invention further includes an interactive online wagering game. The game includes a plurality of participants who receive an initial number of credits in respective participant accounts for use in selectively wagering credits on a finite number of competitions in a series of scheduled competitions. Participants selectively wager on the outcome of one or more competitions in the series of competitions before each competition or set of competitions. The results of each participant wager are determined based on the outcomes of each completed competition in the series of scheduled competitions, and each participant's account is credited or debited commensurate with the outcomes of each participant's respective wagers. Participants whose accounts reach a zero balance are eliminated from wagering on future scheduled competitions in the series. One or more winning participants are determined based on the highest participant account balance or balances after completion of the final competition in the series of competitions.

The invention also includes a computer-readable medium comprising software. The software is configured to register a plurality of game participants to compete against one another in a wagering contest. The software also is capable of establishing and maintaining a unique credit account for each registered game participant. The software is further configured to accept one or more wagers from registered participants before each competition in a series of scheduled competitions, and to credit and debit each unique credit account commensurate with the results of each game participant's wager or wagers subsequent to completion of each associated competition in the series of scheduled competitions. The software also is capable of ranking the game participants based upon the participants' account balances after completion of a final competition in the series of competitions.

These and other aspects of the invention will be best understood from a reading of the following detailed description, together with the drawings.

### BRIEF DESCRIPTION OF THE DRAWINGS

FIG. 1 is a flow chart showing one embodiment of wagering contest method according to the invention; and

FIG. 2 is a schematic representation of one embodiment of a system for practicing the method depicted in FIG. 1.

### DETAILED DESCRIPTION

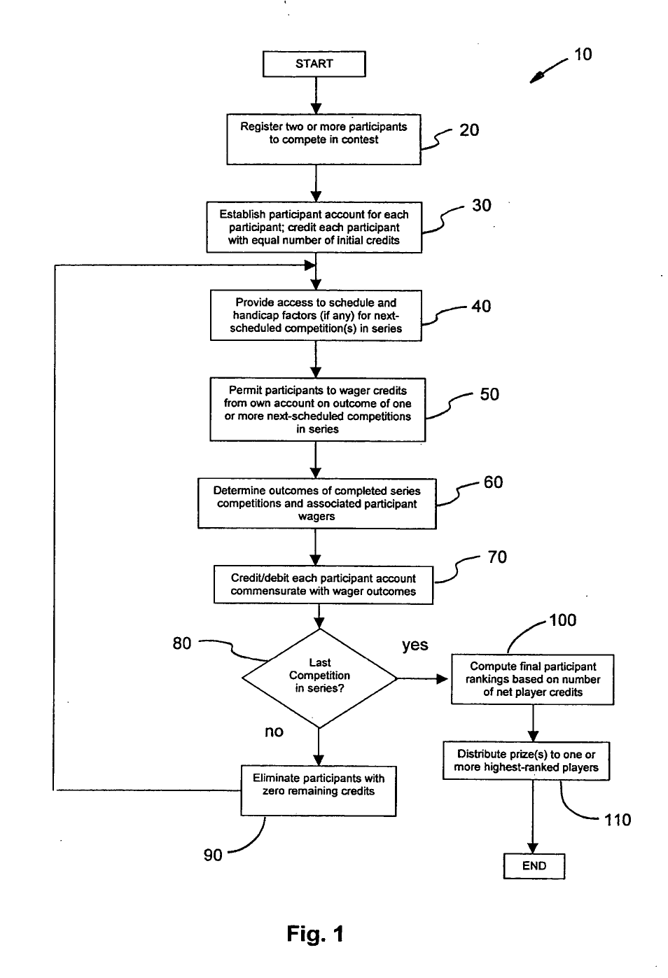

One embodiment of an interactive wagering game or contest method 10 according to the invention is shown in FIG. 1. The method 10 is particularly suited for play in an interactive Internet format whereby participants in various remote locations can participate together. In this method, game participants register 20 to compete against one another in an interactive wagering contest. A participant registration fee may be collected from each participant using known electronic payment systems and methods. For example, participants may provide a valid credit card number and other personal verification information via a web browser interface. Alternatively, registration may be free to participants. For example, a game method 10 with free participant registration may be used to entice persons to visit a hosting commercially sponsored website. The number of participants permitted to register for a particular contest may be limited to a predetermined number of participants. In addition, participants may be permitted to register to compete against a finite group of other known participants in a private group or “league”.

After participants register 20, a separate game account is established 30 for each registered participant. An identical initial allotment of points or credits “N_{i”} is credited to each participant's game account before the start of the contest. Preferably, participants are permitted to ascertain their personal game account balances at any time during the contest.

Participants are provided access 40 to a schedule of upcoming competitions on which the participants will be permitted to wager credits from their game accounts. The schedule identifies one or more future competitions that are next-scheduled competitions in a series of competitions. For example, participants may be provided a schedule of college or professional sporting events that will occur during a specific period of time such as on a particular day, or during a particular week or weekend. The sporting events may involve any competitive sport, such as football, baseball, basketball, hockey, automobile racing, or the like. Though the invention is ideally suited for simulated wagering on a series of sporting events, the method also can be used to wager on a series of non-sports events. For example, the system may be used to wager on a series of election outcomes or a series of judicial decisions. For the purpose of illustration only, however, the game, method, and system according to the invention primarily is described below in terms of a contest involving simulated wagers on a series of sporting events, such as football games.

In one embodiment of the gaming method 10, participants register 20 to compete in a wagering contest involving periodic wagering of points or credits on various teams during a series of competitions that span a complete football season. For example, the contest may involve an entire National Football League (“NFL”) or NCAA college football season. In such a contest method 10, participants may be provided access 40 to a schedule of games or competitions which will be played during the next upcoming weekend, for example, and which may be wagered upon by participants before the actual games. The schedule may include all league games for the next upcoming weekend, for example, or may include only a subset of all such games. Handicap factors such as point spreads and/or over/under point totals also may be provided for each eligible game.

Such handicap factors may be considered in determining the outcome of a particular wager by a participant. For example, if a participant wagers “n” credits on Team A to defeat Team B, and Team A is favored to win the game by 4 points, the participant will win the wager only if Team A defeats Team B by more than 4 points. If Team A loses the game or wins by fewer than 4 points, the participant loses the bet and his or her wagered credits. If Team A beats Team B by exactly 4 points, a “push” results, and the player neither wins nor loses the bet. In such a case, no credits are credited or debited from the player's account. The published handicap factor(s) for an upcoming competition may be established by a specific established odds maker. For example, the odds to be applied in the game 10 may be established by nationally known odds maker Danny Sheridan, or another reputable odds maker.

From the schedule of next-scheduled competitions or games, participants are permitted to wager credits 50 from their accounts on one or more scheduled competitions in the series of competitions. Participants may only be permitted to wager credits 50 on a predetermined maximum number of games within a set or round of of next-scheduled games. For example, a participant may be permitted to wager on a maximum of three games from a total of sixteen scheduled NFL football games to be played during a particular week or weekend. A participant may elect to wager all or a portion of his or her account credits on a single next-scheduled game, or may split his or her wager between multiple next-scheduled games, up to the maximum number of permitted game wagers. All participant wagers must be placed before a predetermined wager cutoff time. For example, all wagers may be required to be completed before the start of the first of a round of next-scheduled games. All participant wagers are electronically recorded and stored. Preferably, each participant is required to wager a predetermined minimum number of credits on at least one game during each round of wagering. For example, each participant may be required to wager at least 100 points or credits in each wagering round. If a player fails to wager the minimum number of points or credits during any round of wagering, the minimum number of points or credits are deducted from the players account for the missed round.

Following completion of the last of the round of competitions or games in the series, the outcomes of all completed competitions are determined 60. Based upon the determined competition outcomes, each participant account is credited or debited points or credits commensurate with the result of each participant's wager or wagers. Lost wagers result in corresponding account debits, and successful wagers result in corresponding account credits. Once all participant account balances are determined, interim account balances may be published and ranked for comparison between contest participants.

If the prior round of completed competitions is not the last in the series of competitions, play continues as described above for another round of next-scheduled competitions. This result is indicated by arrow 89 in FIG. 1. For example, if an NFL football season is not yet complete, participants may be permitted to wager on one or more NFL games scheduled for the next weekend in another round of participant wagers. The participant wagering process is identical to the process described above, and as shown in steps 40-70 of FIG. 1. Preferably, participants whose account balances reach zero credits are eliminated 90 from any further wagers on any future competitions in the series. For example, a participant who unsuccessfully wagers all of the credits in his or her account in a particular round of wagers loses all such credits, and is eliminated from further play.

The wagering process 40-70 described above is repeated until the last competition or round of competitions in the series of competitions is completed 80. The number of rounds of wagering 40-70 in a particular contest may be any predetermined number of rounds. For example, in an NFL wagering contest, the contest may continue through the end of the regular NFL season, through only a portion of the season, or may continue through the regular season and playoff games.

Once the results of a final round of wagers are determined, final participant rankings are computed 100 based on the final number of points or credits in each participant's account. Final participant rankings may be published, and the participant with the highest final account balance is established as the overall contest winner. One or more prizes may be distributed 110 to the overall winner and one or more other highest-ranked participants. Prizes may include cash, merchandise, or other valuable items, services, or benefits.

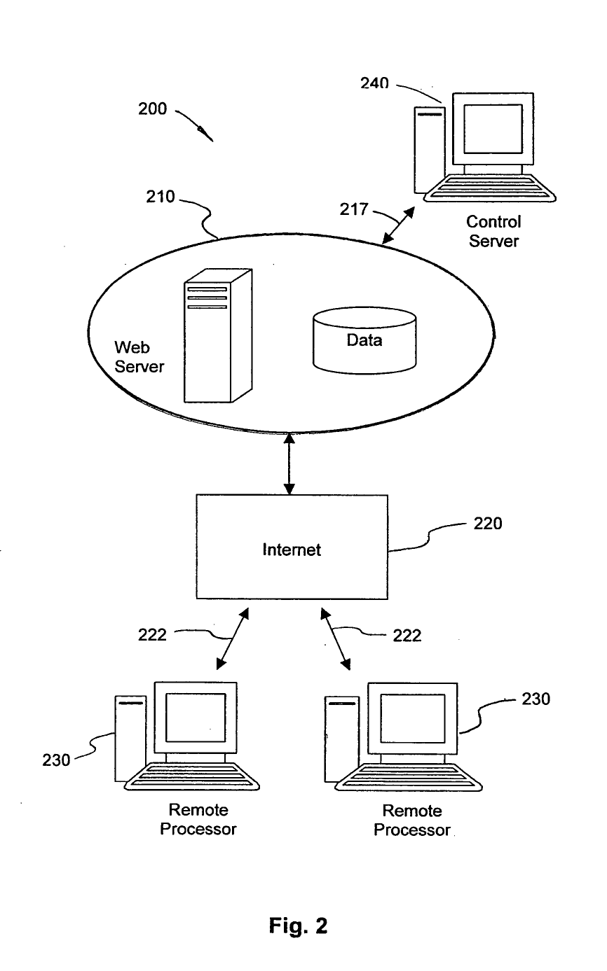

The invention also includes a system for electronic gaming. One embodiment of such a system 200 is shown in FIG. 2. In this embodiment, the system 200 includes at least one host server 210. One or more administrator or control servers 240 may be connected in communication 217 with the host server 210 for controlling and managing operation of the host 210. A plurality of remote processors 230, such as personal computers, selectively communicate 222 with the host server 210. In the arrangement 200 shown in FIG. 2, the communication link is via a wide area network such as the Internet. Alternatively, the system 200 may be arranged as a local area network.

The host server 210 and/or control server 240 is configured and programmed to perform a number of game activities or functions as follows:
(a) register a plurality of remote game participants to compete against one another;
(b) establish and maintain a unique point or credit account for each registered game participant;
(c) accept one or more wagers from registered participants prior to each competition or round of competitions in a series of scheduled competitions;
(d) credit and debit each unique credit account commensurate with the results of each game participant's wager or wagers subsequent to completion of each associated competition in the series of scheduled competitions; and
(e) rank the game participants based upon the participants' account balances after completion of a final competition in the series of competitions.
   A plurality of remote processors 230 in communication with the host computer 210 permit the game participants to interact with the host computer 210 to register to participate, selectively initiate wagers on scheduled competitions, and selectively view one or more credit account balances from the host computer 210. Participants may also be permitted to access other game-related information or functions from the host computer 210 via the remote processors 230, such as contest rules or player standings, for example.

An example of a set of contest rules that may be used in connection with a game method and system for an NFL football wagering contest according to the invention is as follows:
1. Generally, all legal residents of the 50 United States, Washington, D.C. and Canada (excluding Puerto Rico and Quebec) who are 18 years of age or older are eligible to play. In jurisdictions where the age of majority is not 18 years, a player must be the age of majority in the player's jurisdiction to receive any winnings from the contest. Residents of Montana, Vermont, Louisiana, Arizona, Florida, Iowa and Maryland are not eligible to win prizes. The game is void where prohibited.
2. Players must register before the start of the NFL regular season. Each eligible registered player or participant begins the NFL season with 5100 points or credits (300 credits for each of the seventeen weeks of play in the NFL regular season).
3. Player picks are made against the point spreads published by Danny Sheridan's line each Tuesday of game weeks. Point spreads for scheduled games will be posted each Thursday before a weekend of scheduled games. Players may not wager points on any game for which no line has been established. Any wagers placed on a game with no line will be ignored.
4. Each week, each player must wager a minimum of 100 credits on one or more current games. A player may wager any whole number of credits up to the number of credits in the player's account. Wagers may be placed on one, two, or three games. Total winnings for a week of games are added or subtracted to a player's account to provide a player's current score. All wagers for a given week must be entered before the first kickoff on game Sundays. When games in a particular week of play are played on a day that is prior to a game Sunday (Thursday or Saturday, for example), a player must submit any wager on an early game together with wagers on any other game that weekend prior to the kickoff of the earliest game. No parlaying of wagers is permitted between games in the same game week.
5. In order to win a wager, a player's selected favored team must win by more than the established point spread, or a player's selected underdog team must lose by fewer points than the established point spread. In the event of a “push” (favored team wins by exact point spread), a player neither wins nor loses a wager.
6. Any player who fails to wager at least 100 points on at least one game in any game week will be debited 100 points for that week.
7. At any time during the season, if a player loses all credits in his or her account, the player is eliminated from further participation. If a player's credit total is less than the minimum weekly bet requirement (100 points), a player is required to wager all remaining credits on at least one of the upcoming week's games, or the player wil be eliminated from the contest.
8. The winner of the contest is that player with the highest number of points or credits after completion of the final NFL regular season games. Winnings may be awarded to other highly ranked players depending on the total number of players competing in the contest.

Various embodiments of the invention have been described above to illustrate various aspects of the invention. Persons of ordinary skill in the art will recognize that certain modifications can be made to the described embodiments without departing from the invention. All such modifications are intended to be within the scope of the appended claims.

1. An interactive gaming method comprising:
(a) registering a plurality game participants;
(b) establishing an electronic game account for each registered game participant, each game account including an identical number of initial account credits as an initial account balance;
(c) accepting one or more electronic credit wagers from each registered participant on one or more scheduled competitions in a series of scheduled competitions, wherein each credit wager from any game participant on a particular scheduled competition in the series is accepted only before the scheduled competition;
(d) determining the outcome of each scheduled competition;
(e) adjusting the number of credits in each game participant's account balance commensurate with the outcome each game participant's wager or wagers on each completed competition or competitions in the series; and
(f) determining a final account balance for each participant after completion of a final competition in the series of competitions.

2. An interactive gaming method according to claim 1 wherein the series of scheduled competitions comprises a series of sporting events.

3. An interactive gaming method according to claim 2 wherein the series of sporting events includes at least one event selected from the group consisting of an American football game, a baseball game, a basketball game, a hockey match, a soccer match, a horse race, and an automobile race.

4. An interactive gaming method according to claim 1 and further comprising eliminating any game participant having a current net account balance of zero credits from further electronic wagering on any future scheduled competition or competitions in the series.

5. An interactive gaming method according to claim 1 wherein participants are required to wager a minimum number of credits on at least one next-scheduled competition in the series.

6. An interactive gaming method according to claim 1 and further comprising awarding one or more prizes to the game participant or participants having the largest account balance or balances after completion of the final competition in the series.

7. An interactive gaming method according to claim 1, wherein determining the outcome of each scheduled competition includes handicapping competitors in the scheduled competition.

8. An interactive gaming method according to claim 7 wherein handicapping competitions includes establishing an effective point spread for each competition in the series.

9. An interactive gaming method according to claim 8 wherein the effective point spreads are established based on published point spreads from an odds maker.

10. An interactive gaming method according to claim 1 wherein electronically registering a plurality game participants includes accepting a registration fee from each participant.

11. An interactive gaming method according to claim 1 wherein account balances for game participants are published after completion of each scheduled competition.

12. A system for electronic gaming, the system comprising at least one host computer, the host computer being configured and programmed to:
(a) register a plurality of remote game participants to compete against one another;
(b) establish and maintain a unique credit account for each registered game participant;
(c) accept one or more wagers from registered participants before each competition in a series of scheduled competitions;
(d) credit and debit each unique credit account commensurate with the results of each game participant's wager or wagers subsequent to completion of each associated competition in the series of scheduled competitions;
(e) eliminate a participant whose account balance is zero from further wagering on future scheduled competitions; and
(f) rank the game participants based upon the participants' account balances after completion of a final competition in the series of competitions.

13. A system for electronic gaming according to claim 12 wherein the host computer is in communication with a plurality of remote processors via a wide area network.

14. A remote processor in communication with a host computer, the remote processor being configured and programmed to permit a person to:
(a) interactively register to participate in a simulated wagering contest;
(b) selectively initiate a plurality of wagers of allotted points or credits on a series of scheduled competitions; and
(c) selectively view one or more point or credit balances on the host computer.

15. An interactive wagering game comprising a plurality of steps including:
(a) an initial number of credits are alotted to a plurality of game participant accounts for use by participants to selectively wager credits on a finite number of competitions in a series of scheduled competitions;
(b) participants selectively wager credits on the outcome of one or more competitions in the series of competitions prior to each competition;
(c) results of each participant wager are determined based on the outcomes of each completed competition in the series of scheduled competitions, and credits are credited or debited to or from each participant's account commensurate with the outcomes of each participant's respective wagers; and
(d) one or more winning participants are determined based on the highest participant account balance or balances after completion of the final competition in the series of competitions.

16. An interactive online wagering game according to claim 15 wherein a ranking of participant account balances is published after completion of each scheduled competition.

17. An interactive online wagering game according to claim 15, the game further comprising awarding a prize to at least one game participant having a highest account balance after completion of a final competition in the series of competitions.

18. An interactive online wagering game according to claim 15 wherein the series of competitions includes a series of sporting events.

19. An interactive online wagering game according to claim 18 wherein the series of sporting events comprises events selected from the group consisting of American football games, baseball games, basketball games, hockey matches, soccer matches, horse races, and automobile races.

20. An interactive online wagering game according to claim 15 and further comprising preventing participants with accounts that reach zero from wagering on future scheduled competitions.

21. An interactive online wagering game according to claim 15 wherein the series of competitions includes at lease one competitive event that is not a sports event.

22. A computer-readable medium comprising software, the software being configured to:
(a) register a plurality of remote game participants to compete against one another;
(b) establish and maintain a unique credit account for each registered game participant;
(c) accept one or more wagers from registered participants before each competition in a series of scheduled competitions;
(d) credit and debit each unique credit account commensurate with the results of each game participant's wager or wagers subsequent to completion of each associated competition in the series of scheduled competitions;
(e) rank the game participants based upon the participants' account balances after completion of a final competition in the series of competitions.
